(19) United States
(12) Patent Application Publication
(10) Pub. No.: US 2026/0062569 A1
(43) Pub. Date: Mar. 5, 2026

(54) FAST-DRYING COMPOSITIONS FOR SCREEN PRINTING

(71) Applicant: VECTOR ELECTRONICS Sp. z o.o., Torun (PL)

(72) Inventors: Daniel JANCZAK, Torun (PL); Sandra LEPAK-KUC, Torun (PL); Lucja DYBOWSKA-SARAPUK, Torun (PL); Tomasz RACZYNSKI, Torun (PL); Robert SOTKIEWICZ, Torun (PL); Malgorzata JAKUBOWSKA, Torun (PL)

(21) Appl. No.: 19/312,478

(22) Filed: Aug. 28, 2025

(30) Foreign Application Priority Data
Aug. 28, 2024 (PL) P.449599

(51) Int. Cl. C09D 11/033; C08K 3/04; C08K 7/00; C08K 9/08; C09D 7/40; C09D 7/62; C09D 11/102; C09D 11/106; C09D 11/52

(52) U.S. Cl. CPC C09D 11/033; C08K 3/04; C08K 7/00; C08K 9/08; C09D 7/62; C09D 7/70; C09D 11/102; C09D 11/106; C09D 11/52; C08K 2201/001; C08K 2201/005; C09D 7/66

(57) ABSTRACT

A screen printing composition that includes a vehicle and a functional filler. The functional filler is selected from: (i) silver flakes or (ii) a mixture of flake graphite with conductive carbon black. The vehicle contains at least one solvent, present in an amount of 89-95 wt % of the vehicle, selected from α-terpineol, butyl diglycol acetate (BDGA), dibutyl phthalate (DBP), ethanol, and ethylene glycol, together with at least one binder, present in an amount of 5-11 wt % of the vehicle, selected from polymethyl methacrylate (PMMA), polyvinylidene fluoride (PVDF), polyurethane (PU), styrene-butadiene-styrene (SBS), and ethyl cellulose (EC).

### TECHNICAL FIELD

The present invention relates to fast-drying compositions for screen printing, a method for producing thereof, and its use for the production of resistive and conductive layers.

### BACKGROUND

Specialized compositions for screen printing, such as pastes and inks, typically comprise two main components: a vehicle and a functional filler. The vehicle, acting as the binder matrix, plays a crucial role in screen printing compositions. It provides the rheological properties required for screen printing, including shear-thinning behavior, appropriate thixotropy, and viscosity adapted to the printing technique and screens used, generally ranging from 100 to 10 Pa·s. Meeting these requirements ensures good printability and high quality of the printed patterns, both of which depend on selecting the proper vehicle composition. The vehicle also influences adhesion of the printed structures to the substrate; the type and quantity of the vehicle largely determine adhesion. At the same time, the vehicle must be selected to provide the required drying time of the layers after printing. For rapid drying, the vehicle should contain low-boiling solvents and a minimal amount of polymer. However, sufficient polymer content is still necessary to maintain good adhesion and rheological properties.

The organic vehicle used in screen printing compositions (pastes and inks) generally comprises two basic components: a solvent and a binder (resin). One challenge in selecting these components lies in ensuring their compatibility. Furthermore, both the type of material and the ratio of solvent to binder significantly influence the properties of the composition and the resulting printed structures. For fast-drying formulations, the use of low-boiling solvents is essential. However, in order to achieve the required shear-thinning properties, thixotropy, and effective wetting of the functional filler, it is often necessary to incorporate mixtures that also contain more viscous solvents or diluents with higher boiling points.

Thus, the proper selection of the vehicle is a key step in developing screen printing compositions, whether conductive or resistive. This is a complex process that requires experience, knowledge of materials, chemical expertise, and extensive testing.

In addition to the vehicle, screen printing compositions include a functional filler, which provides the desired electrical properties. Beyond selecting the appropriate material, the functional filler must also undergo specialized preparation as an initial step in the production process. Subsequently, the filler must be dispersed in the organic vehicle to form a uniform screen printing composition.

Rheological testing plays a crucial role in the development of screen printing compositions for printed electronics. Only formulations with viscosity tailored to the specific printing technique can ensure high-quality tracks and patterns.

Various screen printing compositions are already known in the prior art for use in printed electronics. Nevertheless, there remains a continuing demand for new compositions with improved properties that meet current market requirements.

### SUMMARY OF THE INVENTION

The invention provides screen printing compositions comprising a specifically selected polymer vehicle and a functional filler (also referred to as a functional solid or functional particulate phase). The invention also relates to a method of producing such compositions and to their use in manufacturing resistive and conductive layers.

The invention concerns a screen printing composition that includes a vehicle and a functional filler, wherein the functional filler is selected from: (i) silver flakes or (ii) a mixture of flake graphite with conductive carbon black. The vehicle comprises at least one solvent, present in an amount of 89-95 wt % of the vehicle, selected from α-terpineol, butyl diglycol acetate (BDGA), dibutyl phthalate (DBP), ethanol, and ethylene glycol, together with at least one binder, present in an amount of 5-11 wt % of the vehicle, selected from polymethyl methacrylate (PMMA), polyvinylidene fluoride (PVDF), polyurethane (PU), styrene-butadiene-styrene (SBS), and ethyl cellulose (EC).

In preferred embodiments, the mixture of flake graphite with conductive carbon black contains less than 5 wt % of carbon black. A preferred vehicle composition comprises α-terpineol in an amount of 0-31 wt %, BDGA in an amount of 50-82 wt %, and DBP in an amount of 9-10 wt %, with EC as the binder in an amount of 5-11 wt %. In another preferred embodiment, the vehicle solvent consists of 82 wt % of BDGA and 9 wt % of DBP, while the binder is 9 wt % EC.

Preferably, the silver flakes have a size of up to 10 μm, more preferably between 0.5 and 2 μm. The mixture of flake graphite with conductive carbon black is preferably sieved through a mesh with an aperture of 500-50 μm. The overall composition preferably contains 60-90 wt % of the vehicle (more preferably 70-80 wt %) and 10-40 wt % of the functional filler (more preferably 20-30 wt %). In another embodiment, the composition comprises 10-50 wt % of the vehicle (preferably 20-30 wt %) and 50-90 wt % of the silver flakes (preferably 70-80 wt %).

The invention further relates to a method for producing the composition, wherein the raw material components of the functional filler are surface-treated with a surfactant in solution, followed by solvent evaporation. The functional filler thus obtained is then combined with the vehicle. When the filler comprises a mixture of flake graphite with conductive carbon black, the mixture is prepared by mixing, sieving, and deagglomeration, preferably using ultrasonic dispersion in toluene, followed by solvent evaporation to obtain a dry powder. Functionalization is preferably performed in toluene with a surfactant, followed by ultrasonic dispersion and solvent removal.

After the functional filler is combined with the vehicle, the mixture is preferably ground with simultaneous dilution, then subjected to sequential dispersion, milling, and redispersion. Grinding is preferably performed in a mortar grinder. Dispersion is preferably carried out using a high-shear mixer with rotational speed gradually increasing to 14 000 rpm. Milling is preferably performed on a three-roll mill with silicon carbide rollers at 30-200 rpm, with roller gaps of 30 μm, 15 μm, and 5 μm, respectively.

The compositions according to the invention are suitable for producing resistive or conductive layers. An important advantage is their ability to form printed layers on both rigid and flexible substrates, enabling production of both carbon-based and silver-based compositions. Due to the use of a low-boiling vehicle, the printed resistive and conductive layers dry in less than 15 seconds through flash evaporation.

Another advantage of the carbon-based compositions is that agglomerates at high filler loading do not exceed 20 μm. The compositions allow continuous carbon and silver layers to be produced over the full working area of a screen printer, in formats up to 0.6 m². Printed layers exhibit favorable electrical and structural properties, such as sheet resistance of 118Ω/□ a thickness below 11 μm and a roughness of 1.55 μm. A double-pass print through a polyester mesh of ˜70 T yields a layer with 1 mil thickness and sheet resistance below 50Ω/□, with only 1.3% standard deviation in sheet resistance for single-pass prints. Silver-based compositions yield conductive layers with sheet resistance below 0.5 Ω/□ at a thickness under 10 μm, with high uniformity and reproducibility.

It was found that α-terpineol is not essential: reducing its content does not significantly affect print quality. Proper rheology can instead be maintained by adjusting EC binder content. Optimizing binder content ensures both good conductivity and rapid drying, while minimizing binder maintains optimal composition balance.

An additional advantage of the disclosed method is that dispersing the functional filler in the polymer vehicle after prior deagglomeration results in layers with unprecedented repeatability.

These and other features, aspects and advantages of the invention will become better understood with reference to the following drawings, descriptions and claims.

### DETAILED DESCRIPTION

The invention is further illustrated below by way of exemplary embodiments. The description is not to be taken in a limiting sense, but is made merely for the purpose of illustrating the general principles of the invention.

### Example 1—Production of a Fast-Drying Composition for Screen Printing Based on a Mixture of Flake Graphite with Conductive Carbon Black

In the first stage, the functional filler was prepared. Carbon black and graphite were weighed separately in proportions such that the final mixture contained 5 wt % of carbon black. The components were then mixed and sieved through a 200 μm nylon sieve.

Next, the mixture was deagglomerated using ultrasonic dispersion in a low-boiling solvent (toluene) for 3 hours at 300 W. The solvent was subsequently evaporated to obtain the functional filler in the form of a dry powder.

In the second stage, the obtained powder was further deagglomerated by functionalizing its surface with a surfactant in the presence of toluene, using ultrasonic treatment. For this step, 5 wt % of a surfactant from the MALIALI SC-0505K series (NOF, Japan) was employed. After functionalization and solvent evaporation, a dry powder of functionalized filler was obtained, ready for incorporation into the fast-drying composition.

In the third stage, the final composition was prepared by combining the functional filler with the vehicle and dispersing the mixture. Initially, the filler and the vehicle were ground together for 2 hours in a mortar grinder, while simultaneously adding small amounts of dibutyl phthalate (DBP) as a diluent. This controlled addition ensured the minimum necessary amount of diluent for proper rheology.

The pre-mixed composition was then dispersed using a high-shear mixer. Following this, the material underwent repeated three-roll milling on silicon carbide rollers (three passes at 100 rpm, with roller gaps of 30 μm, 15 μm, and 5 μm). The resulting paste was again dispersed using a high-shear mixer for 3 minutes, with the rotational speed gradually increased to 14 000 rpm.

The vehicle for combination with the filler was prepared separately by dissolving the binder in the base solvent BDGA. Dissolution was carried out on a magnetic stirrer at 50° C. for 6 hours at 150 rpm. Afterward, the remaining components were added and mixed for an additional 2 hours at 30° C. (200 rpm) until complete homogenization was achieved. The vehicle was then ready for use in producing fast-drying screen printing compositions.

During development, multiple vehicle formulations were tested, as summarized in Table 1. All compositions met the printability requirements, but vehicle N30 yielded the most favorable results.

TABLE 1
Tested fast-drying vehicle compositions

| Vehicle | α-terpineol | BDGA | DBP | EC |
|---|---|---|---|---|
| symbol | [wt %] | [wt %] | [wt %] | [wt %] |
| N19 | 30 | 50 | 10 | 10 |
| N20 | 30 | 55 | 10 | 5 |
| N21 | 30 | 53 | 10 | 7 |
| N22 | 31 | 53 | 9 | 7 |
| N23 | 20 | 64 | 9 | 7 |
| N24 | 20 | 62 | 9 | 9 |
| N25 | 20 | 60 | 9 | 11 |
| N26 | 10 | 70 | 9 | 11 |
| N27 | 0 | 80 | 9 | 11 |
| N28 | 0 | 86 | 9 | 5 |
| N29 | 0 | 84 | 9 | 7 |
| N30 | 0 | 82 | 9 | 9 |

Positive results were also obtained using other binders, in particular polymethyl methacrylate (PMMA), polyvinylidene fluoride (PVDF), polyurethane (PU), and styrene-butadiene-styrene (SBS).

### Example 2—Production of a Fast-Drying Composition for Screen Printing Based on Silver Flakes

The procedure was the same as in Example 1, except that Amepox AX 20LC silver flakes (Amepox, Poland) with a median particle size of 2 μm were used in place of the graphite/carbon black mixture.

### Example 3—Use of the Fast-Drying Composition for Producing Resistive and Conductive Layers

The compositions prepared according to Examples 1 and 2 were used for printing resistive and conductive layers. Printing was performed on an Aurel 920C screen printer, using a medium-hard (75 Shore A) squeegee set at a 45° angle, with an optimal printing speed of 120-150 m/min. A 77 T polyester screen was employed.

After leveling, the printed layers were dried using an infrared (IR) flash dryer. Drying parameters were set at 170° C. for 15 seconds, which allowed complete solvent evaporation without damaging the 120 μm thick film substrate.

To optimize the compositions, electrical properties of the printed layers were evaluated. Sheet resistance was measured on 1 cm wide tracks of 5 cm and 10 cm length. Measurements were taken for both single-pass and double-pass prints. In the case of silver compositions, only single-pass prints were tested. The average sheet resistance values obtained are summarized in Table 2.

TABLE 2
Sheet resistance of carbon and silver compositions
Carbon compositions

| Funct. | N27 - single-pass | | N30 - single-pass | | N27 - double-pass | | N30 - double-pass | |
|---|---|---|---|---|---|---|---|---|
| filler | Sheet | Std. | Sheet | Std. | Sheet | Std. | Sheet | Std. |
| loading | res. | dev. | res. | dev. | res. | dev. | res. | dev. |
| [wt %] | [kΩ/□] | [%] | [kΩ/□] | [%] | [kΩ/□] | [%] | [kΩ/□] | [%] |
| 22 | 0.24933 | 0.00485 | 0.20083 | 0.00480 | 0.11634 | 0.00177 | 0.09325 | 0.00257 |
| 24 | 0.23068 | 0.00602 | 0.19601 | 0.00320 | 0.10013 | 0.00263 | 0.09133 | 0.00188 |
| 26 | 0.19379 | 0.00568 | 0.18123 | 0.00296 | 0.08647 | 0.00351 | 0.08995 | 0.00508 |
| 28 | 0.14644 | 0.00265 | 0.14632 | 0.00286 | 0.06809 | 0.00128 | 0.07881 | 0.01017 |
| 30 | 0.12980 | 0.00270 | 0.11818 | 0.00148 | 0.05948 | 0.00285 | 0.05976 | 0.00238 |

Silver compositions

| Funct. | | |
|---|---|---|
| filler | N27 - single-pass print | N30- single-pass print |

| loading | Sheet resistance | Std. dev. | Sheet resistance | Std. dev. |
|---|---|---|---|---|
| [wt %] | [Ω/□] | [%] | [Ω/□] | [%] |
| 70 | 0.48151 | 0.02875 | 0.52359 | 0.00734 |

The results demonstrated that carbon compositions with the N30 vehicle exhibited lower sheet resistance than those with the N27 vehicle in single-pass prints. In double-pass printing, both vehicles produced similar sheet resistance values. For silver pastes, the N27-based composition provided lower sheet resistance.

While the invention has been described with respect to a limited number of embodiments, it will be appreciated that many variations, modifications and other applications of the invention may be made. Therefore, the claimed invention as recited in the claims that follow is not limited to the embodiments described herein.

1. A composition for screen printing, the composition comprising a vehicle and a functional filler,
wherein the functional filler is selected from (i) silver flakes and (ii) a mixture of graphite flakes with conductive carbon black; and
wherein the vehicle comprises:
89-95 wt % of at least one solvent selected from α-terpineol, butyl diglycol acetate (BDGA), dibutyl phthalate (DBP), ethanol and ethylene glycol; and
5-11 wt % of at least one binder selected from polymethyl methacrylate (PMMA), polyvinylidene fluoride (PVDF), polyurethane (PU), styrene-butadiene-styrene (SBS) and ethyl cellulose (EC).

2. The composition of claim 1, wherein the mixture of graphite flakes with conductive carbon black comprises less than 5 wt % of carbon black.

3. The composition of claim 1, wherein the vehicle solvent comprises butyl diglycol acetate (BDGA) in an amount of 50-82 wt % of the vehicle, dibutyl phthalate (DBP) in an amount of 9-10 wt % of the vehicle, and optionally α-terpineol in an amount of up to 31 wt % of the vehicle, and the binder is ethyl cellulose (EC), in an amount of 5-11 wt % of the vehicle.

4. The composition of claim 3, wherein the vehicle consists of 82 wt % of butyl diglycol acetate (BDGA), 9 wt % of dibutyl phthalate (DBP) and 9 wt % of ethyl cellulose (EC), all percentages being by weight of the vehicle.

5. The composition of claim 3, wherein the silver flakes have a size of up to 10 μm, preferably 0.5-2 μm.

6. The composition of claim 1, wherein, when the functional filler is the mixture of graphite flakes with conductive carbon black, the mixture has been sieved through a mesh with an aperture of 500-50 μm.

7. The composition of claim 1, comprising 60-90 wt % of the vehicle, preferably 70-80 wt %, and 10-40 wt % of the functional filler, preferably 20-30 wt %, all percentages being by weight of the composition.

8. The composition of claim 1, comprising 10-50 wt % of the vehicle, preferably 20-30 wt %, and 50-90 wt % of the silver flakes, preferably 70-80 wt %, all percentages being by weight of the composition.

9. A method for producing a composition for screen printing, the composition comprising a vehicle and a functional filler, the method comprising:
providing the functional filler, selected from (i) silver flakes and (ii) a mixture of graphite flakes with conductive carbon black;
providing the vehicle that comprises:
89-95 wt % of at lease one solvent selected from α-terpineol, butyl diglycol acetate (BDGA), dibutyl phthalate (DBP), ethanol and ethylene glycol; and
5-11 wt % of at least one binder selected from polymethyl methacrylate (PMMA), polyvinylidene fluoride (PVDF), polyurethane (PU), styrene-butadiene-styrene (SBS) and ethyl cellulose (EC)
surface-treating the functional filler by contacting it with a solution of a surfactant in a treatment solvent and evaporating the treatment solvent to obtain a surface-treated functional filler; and
combining the surface-treated functional filler with the vehicle.

10. The method of claim 9, wherein, when the raw material is a mixture of graphite flakes with conductive carbon black, the mixture is prepared by mixing graphite and carbon black and subsequently sieving and deagglomerating the mixture.

11. The method of claim 10, wherein sieving is carried out using a nylon sieve with an aperture of 500-50 μm.

12. The method of claim 10, wherein deagglomeration is carried out by ultrasonic dispersion in toluene followed by evaporation of the toluene to obtain a dry powder.

13. The method of claim 9, wherein functionalization is performed in toluene by mixing the raw material with the solvent and the surfactant, subjecting the mixture to ultrasonic dispersion, and then evaporating the solvent.

14. The method of claim 9, wherein, after combining the functional filler with the vehicle, the mixture is ground with simultaneous dilution, then dispersed, calendered and dispersed again.

15. The method of claim 14, wherein grinding is performed in a mortar grinder.

16. The method of claim 14, wherein dispersion is carried out using a high-shear mixer with the rotational speed gradually increased to 14 000 rpm.

17. The method of claim 14, wherein calendering is three-roll milling on silicon-carbide rollers at 30-200 rpm with roll gaps of 30 μm, 15 μm and 5 μm, respectively.

18. A process for forming a resistive layer, comprising screen-printing the composition of claim 7 onto a substrate.

19. A process for forming a conductive layer, comprising screen-printing the composition of claim 8, wherein the functional filler comprises silver flakes, onto a substrate.
